(19) United States
(12) Patent Application Publication
(10) Pub. No.: US 2010/0291824 A1
(43) Pub. Date: Nov. 18, 2010

(54) FABRIC FOR PROCESSING SPUNMELT OR AIRLAID NONWOVENS INCLUDING PROFILED YARNS FOR SOIL RELEASE AND CONTAMINATION RESISTANCE

(75) Inventors: Ralph Roemer, Aachen (DE); Michael Bodnar, Kanata (CA); Lucia Ravoiu, Montreal (CA); Scott Brydges, Westmount (CA); Francois Ayotte, Laval (CA)

Correspondence Address: VOLPE AND KOENIG, P.C., UNITED PLAZA, 30 SOUTH 17TH STREET, PHILADELPHIA, PA, 19103, US

(73) Assignee: ASTENJOHNSON, INC., Charleston, SC (US)

(21) Appl. No.: 12/676,978

(22) PCT Filed: Sep. 5, 2008
(86) PCT No.: PCT/CA08/01567

§ 371 Date: Jun. 7, 2010

(30) Foreign Application Priority Data
Sep. 7, 2007 (CA) 2600307

(51) Int. Cl. B32B 5/26; D03D 25/00

(52) U.S. Cl. 442/246; 428/221; 442/181; 442/239

(57) ABSTRACT

A fabric for use in the production of nonwoven material webs comprises at least one component system of monofilament polymeric yarns in each of the machine and cross-machine directions. At least some of the yarns of at least one system comprise surface roughened yarns having a substantially flat surface exposed in the web-contacting surface, with a surface roughness between 5 μm and 100 μm. The fabric can be woven, optionally including conductive yarns in either or both of the machine or cross-machine directions. The fabric can also be a spiral link construction comprising coils of helically assembled yarns, at least some of which will be surface roughened yarns; surface roughened stuffer yarns can also be provided within the coils. The fabrics have increased resistance to contamination by materials deposited during web formation and improved web release.

### FIELD OF THE INVENTION

The present invention concerns contamination-resistant fabrics useful in the production of nonwoven webs. It is particularly concerned with such fabrics of this type which are intended for use in forming, bonding or drying an airlaid or spunmelt nonwoven and which exhibit resistance to the adhesion of contaminants due to the use of non-circular fabric component yarns in which at least one surface is treated to provide a surface roughness, preferably of between 5 μm and 100 μm, and which surface is oriented towards the nonwoven product being formed.

### BACKGROUND

Fabrics intended for use in forming, bonding or drying nonwoven products such as those manufactured using a spunmelt or airlaid process are well known. These fabrics can be of woven or spiral construction, and may be of single, double or triple layer configurations and variants thereof, such as layer and one-half, extra support double layer, and so on which constructions are well known in the art. It is also known to use shaped yarns in the manufacture of these fabrics so as to improve various properties such as air leakage, volume of entrained air in the fabric, web grip, and so on.

The term “spunmelt” as used herein is intended to refer to nonwoven structures made by extruding molten polymer through spinnerets to form fibers which are in turn laid onto a moving fabric in what are variously referred to in the industry as spunbond, spunlaid and/or meltblown processes. Spunmelt processes are used in the manufacture of spunbond nonwovens, meltblown nonwovens and combinations of the two. An airlaid nonwoven web production process is one in which fibers that have been previously formed are dispersed into a fast moving air stream and then condensed onto a moving screen by means of pressure or vacuum to form a web that is subsequently cohesively bonded by one or more techniques to provide integrity.

A problem common to fabrics used in the production of nonwoven webs in both spunmelt or airlaid processes is the undesirable deposition of droplets of polymeric, latex and other component materials during the web manufacturing process, such as from leaks or spatter from the spinnerets or during consolidation and bonding. Other contaminants may be deposited on the conveying fabric from a variety of other sources including the fiber components themselves. This undesirable deposition of materials creates blockages in the fabric that will interfere with the web forming process and result in defects in the web. Although various cleaning methods are commonly employed to ensure the suitability of the fabrics, these contaminants are often difficult to remove and, if sufficient amounts are able to accumulate, may necessitate the premature removal of a fabric or a disruption in the web forming process, both of which are undesirable.

A further problem associated with the production of these nonwoven webs is the generation of static electricity during the manufacturing process. Both the fibers and the fabric upon which the web is conveyed will tend to carry an electrostatic charge that is imparted during the process. This can cause particularly significant problems with the production of multilayer webs, as the successive layers will tend to repel each other; further, the component fibers will tend to cling to the press rolls employed to compress the initial deposit of fibers thus causing defects in the web. These problems are exacerbated by increasing line speeds, and increasing numbers of layers in the web since the static charge tends to accumulate. Provisions of some kind need to be employed to address these electric charges, either to dissipate them or use them in an advantageous manner.

US 2003/0208886 (Albany Int./Monnerie et al.) discloses a fabric that is intended to dissipate static electric charges which accumulate during the production of nonwoven webs in a spunbond or meltblown forming process, as well as to minimize air leakage and web flutter. The forming fabric comprises a woven structure including flat monofilaments in either the machine direction (MD), i.e. the direction of travel of the fabric, or the cross-machine direction (CD), i.e. a direction perpendicular to the MD within the plane of the fabric, so as to reduce internal void volume; these yarns may be formed of a conductive material so as to dissipate static charges.

US 2004/0127129 (Albany Int./Shuiyuan et al.) discloses a monofilament with longitudinally oriented grooves and fabrics made therefrom which allegedly exhibit reduced air permeability, and improved sheet grip and air handling. The grooved monofilaments may be incorporated in a fabric as MD yarns, CD yarns or both CD and MD yarns, and can also include a conductive coating for static charge dissipation.

US 2005/0233661 (Heimbach/Best et al.) discloses a papermakers' forming or dryer fabric including specially shaped, roughly rectangular monofilaments. At least one surface of the rectangular profile of the monofilaments includes a series of depressions which, when in use, will be oriented towards the surface of the fabric bearing the paper product conveyed. The depressions are filled with an anti-adhesive coating which aids in rendering the fabric contamination resistant.

U.S. Pat. No. 6,790,796 (Albany Int./Smith et al.) teaches a forming fabric for forming nonwovens which includes a rough surface yarn located on the sheet contacting side of the fabric to prevent slippage of the web. The yarns may be striated monofilaments or twisted/braided multifilaments and may further include a coating for dissipating static charge.

A variety of shaped yarns are known and used in papermaking and other similar textiles intended for forming and/or conveying nonwoven webs. See for example, U.S. Pat. No. 6,875,314; EP 1579060; U.S. Pat. No. 5,097,872; U.S. Pat. No. 5,366,798; U.S. Pat. No. 5,601,691; U.S. Pat. No. 4,988,409; U.S. Pat. No. 5,998,310; others are known and used.

It is known from U.S. Pat. No. 6,773,786 (Asten pGmbH/Kuckart) to incorporate into papermaking dryer fabrics a yarn or similar extrusion product having a roughened surface which is oriented towards the paper product to be conveyed in order to prevent the formation and subsequent release of large agglomerations of pitch, so-called “stickies” and other types of dirt particles on the fabric. Deposition of dirt and related foreign material tends to “plug” (i.e. reduce the air permeability of) the fabric, thus increasing the amount of energy required to dry the paper product, while creating defects such as holes or marks in the product conveyed by the fabric. Cleaning systems are often used to remove some of these contaminants but it is not always possible to install such systems in all environments, and they are not always completely effective in removing these contaminants. U.S. Pat. No. 6,773,786 proposes the use, in papermaker's dryer fabrics, of a cover/fabric in which at least the surface facing the paper web of at least one part of the elements forming the contact surface comprises at least partially an average surface roughness of between 5 μm and 100 μm, this roughness being determined in accordance with DIN EN ISO 4287. A surface roughness of between 10 μm and 80 μm, and preferably between 30 μm and 70 μm are said to be particularly effective in the prevention of dirt particle agglomerations. This surface roughness of the elements appears to reduce the amount of planar surface area available in the fabric for the adherence of particulate and other oily or sticky matter. The surface roughened elements can be yarns, coils or injection-molded segments, and both the elements and the surface roughness profile can be oriented predominantly in either the machine direction (MD), i.e. the direction of travel of the fabric, or the cross-machine direction (CD), i.e. a direction perpendicular to the MD within the plane of the fabric. The surface roughness can be imparted to the elements using a variety of techniques as described, and the elements themselves can be arranged in the textile as required by the end use application.

Use of the invention disclosed in U.S. Pat. No. 6,773,786 is restricted to dryer fabrics for papermaking. The use of elements including surface roughness, in particular of the values indicated in U.S. Pat. No. 6,773,786, in textiles for producing nonwovens in an airlaid or spunmelt process has not been previously proposed, nor is such use suggested in the patent.

It has now been found that, by incorporating fabric components having a surface roughness that is between 5 μm and 100 μm into the product side surface of fabrics intended for the manufacture of nonwovens in either a spunmelt or airlaid process, it is possible to improve the resistance of these fabrics to contamination due to the undesired deposition of materials onto the fabric surface. For the purposes of this invention, “surface roughness” is defined as the condition formed by regular indentations on at least one surface of a yarn, the indentations comprising a series of peaks and valleys; and the surface roughness is quantified as the shortest distance between the lowest point of an indentation and a notional plane between the two adjacent peaks.

Further, it has also been found that such fabrics are easier to maintain in a state of sufficient cleanliness by existing means when such surface roughened yarns are employed.

### SUMMARY

The invention therefore seeks to address the problems discussed above, in relation to fabrics used in the production of nonwoven webs, particularly of the airlaid or spunmelt types. In particular, it seeks to provide such fabrics which are of woven or spiral construction and include, as a portion of either or both their MD and/or CD components, monofilament yarns having a non-circular cross-sectional profile, such as square, rectangular, D-shaped, elliptical, oval, etc., and in particular having a flattened surface oriented when in use towards the nonwoven web. At least this flattened surface of these non-circular yarns is treated prior to assembly into the fabric so as to present an average surface roughness, as defined above, of between 5 μm and 100 μm. When incorporated into the fabrics of this invention so that the roughened yarn surface is oriented towards the web, the ability of the fabrics to resist the adherence of, or to shed contaminants from, their web facing surface is improved. In particular, the fabrics exhibit an improved resistance to the adhesion of undesired materials such as latex and polymers used in the production of the nonwoven webs, as well as other contaminants encountered in both airlaid and spunmelt manufacturing processes. In addition, the flat yarn surfaces tend to reduce so-called “fiber snagging”, a common problem in these processes.

The yarns used in the fabrics of this invention are comprised of any polymer material suitable for use in the manufacture of spunmelt or airlaid nonwovens and the like.

The fabrics of this invention may be woven according to known single, double and triple layer weave designs, and variants thereof, such as are well known in the art, or they may be assembled from a plurality of helical coils interconnected by means of pintles, hinge pins or similar joining yarns or wires, as discussed further below.

The soiling and contamination resistant properties of the fabrics may be enhanced by application of a nanoparticle type contaminant resistant coating such as is described in WO 06/098917 and which is applied either prior to or during use, and by using warp and/or weft yarns comprised of polytetrafluoroethylene (PTFE, or Teflon®).

The invention therefore seeks to provide a fabric for use in the production of a nonwoven web of material, having a web-contacting surface and comprising a plurality of component systems of monofilament polymeric yarns, including at least one system of machine direction yarns and at least one system of cross-machine direction yarns

wherein at least some of the yarns of at least one system
comprise surface roughened yarns having a substantially flat surface which
(i) is exposed in the web-contacting surface and
(ii) has a surface roughness between 5 μm and 100 μm.

At least one surface of these surface roughened yarns is treated prior to assembly into the fabric so as to present to the product conveyed an average surface roughness, as defined above, of between 5 μm and 100 μm. Preferably, the average surface roughness of the yarns is between 10 μm and 80 μm; more preferably the average surface roughness is between 30 μm and 70 μm.

The fabric can be woven or otherwise assembled according to any known design appropriate for the intended end use, including single, double and triple layer constructions, as well as known variants thereof, and also including helical coil constructions, as discussed further below. The surface roughened yarns can be included as either the MD or the CD components, or both, but in any case must be located so that their roughened surface appears on the side of the fabric facing the nonwoven product to be formed in a manner that maximizes their exposure to this side. If used in a fabric of spiral construction, the surface roughened yarns should be used to form the spirals or helical coils so that the roughened surface is presented to the product, and as each of two opposing faces, i.e. an upper and a lower face, of the yarns will appear in the product facing surface of the fabric, the yarns should be roughened on each of those two faces. In instances where the space between the coils of the helices is large enough to allow the unwanted deposition of contaminant material into the interior of the fabric, it is beneficial to employ so-called “stuffer” yarns within the interior of the coils, for example in the manner disclosed in U.S. Pat. No. 4,567,077 to Gauthier. By providing at least some of the stuffer yarns with a roughened surface profile in accordance with the invention, the ability of the fabric to shed contaminants during the forming process is further significantly enhanced.

Preferably the surface roughened yarns comprise between from about 30% to about 70% of the material contacting surface area of the fabric, this area being dependent upon the other physical properties required for the chosen fabric construction, but maximized as the greater the surface area of the fabric that includes the exposed roughened surface of these yarns, the more effective the fabric will be to shed contaminants.

Preferably, the surface roughened yarns are oriented in the CD of the fabric. Alternatively, the surface roughened yarns are oriented in the MD of the fabric. As a further alternative, the surface roughened yarns are oriented in both the CD and MD.

The surface roughness property of the yarns themselves can be imparted by any known means such as extrusion, etching or other methods such as are described in U.S. Pat. No. 6,773,786. Preferably the surface roughness property of the yarns is imparted by extrusion.

The yarns preferably have a generally rectangular cross-sectional profile. However, depending on the fabric construction, other profiles such as square, D-shaped, and generally elliptical or ovate are possible. If rectangular shaped, the ratio of the cross-sectional width to the maximum thickness of the yarn should be in the range of from about 1:1 to about 6:1. More preferably, the ratio of the width to the thickness of a rectangular yarn is from about 1:1 to about 3:1. Typically, the thickness dimension of such a yarn will be from about 0.10 mm to about 1.00 mm; preferably the thickness will range from about 0.15 mm to about 0.40 mm, although greater or lesser thicknesses may be employed for certain applications.

The fabrics of this invention preferably also include electrically conductive polymeric yarns which are incorporated so as to be oriented in both the MD and CD to dissipate static charge built up in the fabric during the nonwoven production process, as noted above. If the fabric is a woven structure comprised of interwoven warp and weft yarn systems, then two systems of warp yarns and two systems of weft yarns should preferably be used, one system of each of the weft and warp yarns being comprised of an electrically conductive polymeric yarn material. Alternatively, the conductive yarn material can be provided in only one of either the MD or CD. Suitable conductive yarns include carbon-coated polyamide yarns, such as Resistat CN125 and Resistat CN225, manufactured by Shakespeare Company LLC of Columbia, S.C., USA; but others may also be suitable.

Spiral fabric constructions are generally used to transfer the nonwoven web from the forming zone to another part of the machine. At this point in the production process, the static charge associated with the web tends to be fairly low, the majority of charge having already been dissipated in the forming zone. Such fabrics therefore do not generally require the use of conductive yarns, but the use of surface roughened yarns according to the invention as the yarn components of the interconnected helices is beneficial. In certain circumstances, as noted above, it will also be beneficial to insert into the helices, in the so-called “stuffer” position, surface roughened yarns so as to maximize the surface area of the fabric which is capable of resisting contamination due to the undesired deposition of materials onto the fabric surface.

An example of the fabrics of the invention was woven, using surface roughened yarns in the CD, and was tested for making a non-woven polymer web. The fabric was woven with one and one-half layers, in an 8 shed, under-5, over-3 pattern, having the properties noted in Table A, below. The fabric included conductive yarns of carbon-coated polyamide. All the other yarns were constructed of PET.

TABLE A

| | Fabric A | |
|---|---|---|
| | (Prior Art) | Fabric B |
| Mesh (per cm) | 19.3 × 11.8 | 19.7 × 12 |
| Description | 1.5 layer | 1.5 layer |
| MD yarns | 0.50 mm PET | 0.50 mm PET |
| CD yarns (1) | 0.80 mm PET | 0.50 mm PET |
| CD yarns (2) | 0.35 mm PET | 0.35 × 0.70 mm PET |
| Caliper | 1.80 mm | 1.56 mm |
| Weight | 1082.9 g/m² | 936.9 g/m² |
| Air permeability | 550 cfm/ft² | 475 cfm/ft² |
| FSI | 53.9 | 55.4 |
| Open area | 1% | 0.3% |
| Frame length | 0.39 mm | 0.33 mm |
| Frame width | 0.61 mm | 0.59 mm |

It was found that the fabric had significantly improved properties over the prior art comparison fabric. In particular, improved web formation was achieved, with good web uniformity. Although the spaces between the yarns was less than for the prior art fabric, which contributed to the improved web formation, it was nevertheless significantly easier to clean any polymer residue from the fabric; and there were less loose fibres caught in the yarns, so that web release was significantly improved. There was also less variation of air permeability in the seam area, further contributing to the improved web uniformity.

### BRIEF DESCRIPTION OF THE DRAWINGS

The invention will now be described in relation to the drawings, in which:

FIG. 1 is a perspective view of a part of a fabric of the invention, including conductive yarns;

FIG. 2 is a close-up perspective view of a part of a fabric of the prior art;

FIG. 3 is a close-up perspective view of a part of a fabric of the invention;

FIG. 4 is a top view of a fabric of helical construction, using the surface roughened yarns of the invention;

FIG. 5 is a sectional view along the lines 5-5 in FIG. 4; and

FIGS. 6a to 6e are cross-sectional views of surface roughened yarns suitable for use in the fabrics of the invention.

### DETAILED DESCRIPTION OF THE PREFERRED EMBODIMENTS

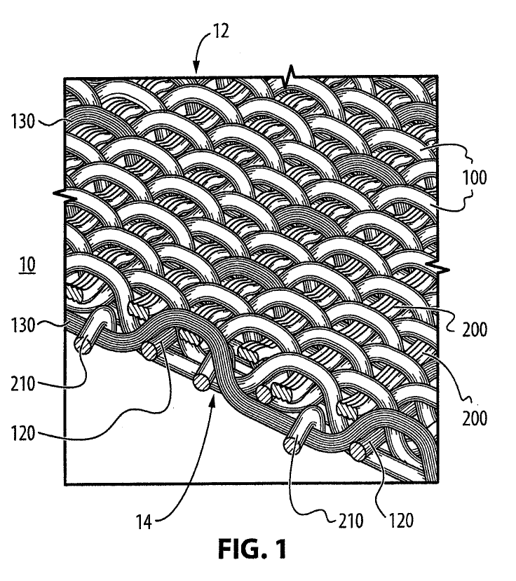

FIG. 1 is an exemplary perspective view of part of a fabric 10 constructed in accordance with the teachings of the present invention, the fabric 10 being designed as a one and one-half layer fabric suitable for forming non-wovens. In this view of the fabric, the upper surface is the forming surface 12 and the lower surface is the machine side surface 14. A set of warp yarns 100 is interwoven with a set of surface roughened weft yarns 200 and a second set of regular weft yarns 210. Introduced at regular intervals into the overall weave pattern are electrically conductive warp yarns 130 and electrically conductive weft yarns 120, so as to assist in dissipating static electric charge built up in the fabric 10 when in use. In this embodiment, the electrically conductive weft yarns 120 are woven as part of the second set of regular weft yarns 120.

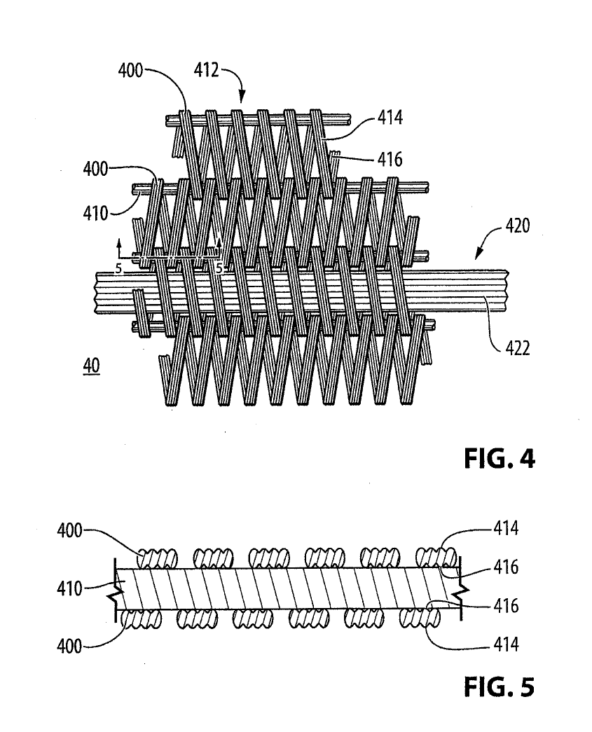

The surface roughened weft yarns 200 of the invention have a surface roughness that is in the range of between 5 μm and 100 μm, and in the fabric of FIG. 1, have a cross-sectional profile of these yarns which is generally rectangular and closely corresponds to that illustrated in FIG. 4 of U.S. Pat. No. 6,773,786, and measures 0.35 mm×0.70 mm, thus having a width to height ratio of approximately 2:1.

In the fabric shown in FIG. 1, the warp yarns 100 have a circular cross-sectional shape with diameter of 0.50 mm, and the weft yarns 210 and the electrically conductive weft yarns 120 have a generally circular cross-sectional shape that is 0.52 mm in diameter. The conductive weft yarns 120 account for 25% of the second set of weft yarns 210, being inserted as every fourth yarn in the second set.

The fabric 10 is woven according to a design that presents the surface roughened weft yarns 200 and the regular weft yarns 210 on the forming surface 12 of the fabric 10 so that a portion of the area of the forming surface 12 is comprised of the surface roughened weft yarns 200, the exposure of the surface roughened weft yarns 200 ranging from about 30% to about 70% depending on fabric construction.

As noted above, the fabric 10 is woven according to a one and one-half layer design in which the warp yarns 100 are interwoven with the surface roughened weft yarns 200 and a second system of weft yarns 300 according to an under-5, over-3 pattern. In this pattern, the warp yarns 100 form a float over one surface roughened yarn 200 and two weft yarns 210 of the second set of weft yarns on the forming surface 12 of the fabric 10, and then float under three surface roughened weft yarns 200 and two of the weft yarns 210 of the second set. On the forming surface 12, the weft yarns 200 each float over three and under one warp yarn 100 in each repeat of the weave pattern.

The yarns 200 in this fabric are preferably formed from polyethylene terephthalate (PET) polyester but could be formed from other polymeric materials such as would be suitable for the intended end use. Suitable materials include, but are not limited to, polybutylene terephthalate (PBT), polyethylene naphthalate (PEN), polyethylene, polytetrafluoroethylene (PTFE, or Teflon®), polyamide (nylon), polyphenylene sulfide (PPS), and polyetheretherketone (PEEK). The materials will be selected according to various factors based on the intended end use of the fabric, including considerations of static electricity factors of the use environment, and in particular any factors affecting compatibility with the properties of the polymers to be used in the web to be formed on the fabric.

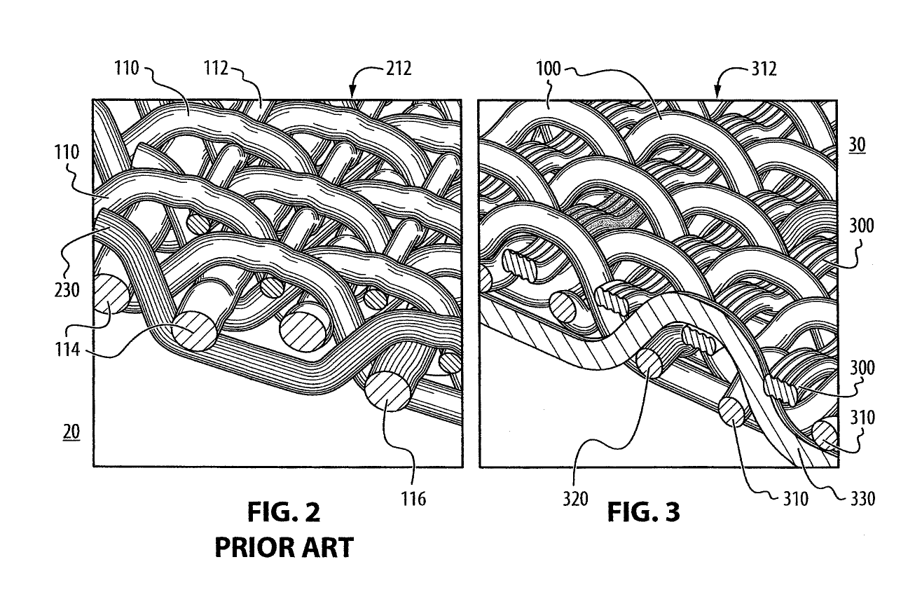

Referring now to FIG. 2, a close-up perspective view of a fabric 20 of the prior art is shown, with which a similar close-up perspective view of a fabric 30 of the invention, shown in FIG. 3, can be compared.

In FIG. 2, the fabric 20 is woven as a one and one-half layer fabric suitable for forming a nonwoven web. Warp yarns 110 are interwoven with a first set of forming side weft yarns 112, of substantially circular cross-section, and a set of larger diameter machine side weft yarns 114. In the fabric illustrated, some of the set of warp yarns 110 are electrically conductive warp yarns 230, and some of the larger weft yarns 114 are electrically conductive weft yarns 116.

By comparison, the fabric 30 of the invention, shown in FIG. 3, has a similar weave pattern to the fabric 20 of FIG. 2. In the fabric 30, warp yarns 100, including regularly located electrically conductive warp yarns 330, are interwoven in an under-5, over-3 pattern, with surfaced roughened weft yarns 300, and regular weft yarns 310, some of the regular weft yarns 310 being electrically conductive weft yarns 320.

In comparing the forming surface 312 of the fabric 30 of FIG. 3 with the forming surface 212 of the fabric 20 of FIG. 2, it can readily be seen that the forming surface 312 provides a less open appearance, and that the upper surfaces of the substantially rectangular surface roughened weft yarns 300 contribute significantly to the forming surface.

Referring now to FIG. 4, a view of the forming surface of a fabric 40 of helical construction is shown, in a weave pattern known in the art, in which yarns 400 are helically woven in a machine direction orientation, around cross-machine direction oriented hinge pins 410. However, in this fabric, appropriate surfaces 414, 416 of the helically woven yarns 400 have been roughened in accordance with the invention. As noted above, as each of two opposing faces of those yarns will appear in turn in the forming surface 412 of the fabric, each of what become the outer faces 414 and the inner faces 416 of the yarns 400 is roughened.

Further, as shown in FIG. 4, to provide yet further contamination resistance to fabrics of helical construction, it is also possible to insert a stuffer yarn 420 within the coils formed by the yarns 400, and to provide at least some of these stuffer yarns 420 with surface roughening on at least an upper surface 422.

FIG. 5, being a cross-section view along the lines 5-5 in FIG. 4, shows the position of the roughened surfaces 414, 416 in relation to the hinge pins 410 about which the helical yarns 400 are wound.

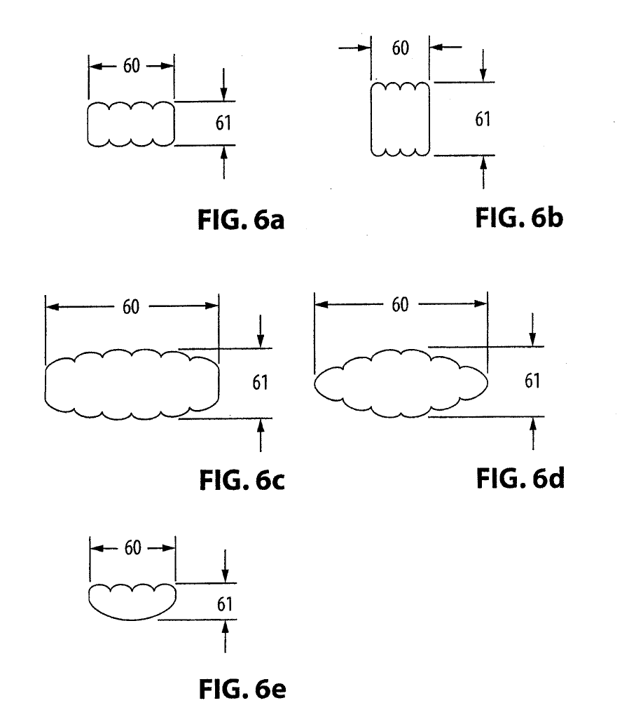

Referring now to FIGS. 6a to 6e, examples of suitable cross-sectional configurations for the surface roughened yarns 200, 300 are shown. In each figure, the width 60 and profile thickness 61 are indicated; the ratio 60:61 between these two dimensions is preferably between 1:1 and 6:1. As noted above, the selection of suitable yarn configurations from these or other configurations will depend on the intended end use of the fabric.

The frequency of occurrence of the electrically conductive yarns 120 and 130 (FIG. 1), 320 and 330 (FIG. 3) in the structure of the fabrics of the invention will be dictated by the intended end use requirements of the fabrics 10, 30 and does not of itself, in general, have a material impact on beneficial soil release characteristics. Suitable conductive yarns are commercially available from several suppliers, including Resistat CN125 and Resistat CN225, as discussed above.

The fabrics of the invention are woven to provide an air permeability that is preferably in the range of from about 300 cfm/ft² to about 1000 cfm/ft² for spunmelt, airlaid and similar nonwoven forming applications, most preferably in the range of about 400 cfm/ft² to about 700 cfm/ft². The fabrics shown in FIGS. 1 and 3 each have an air permeability of about 475 cfm/ft². Fabric air permeability will be chosen in accordance with machine speed and the requirements of the product to be formed using the fabric, and can be easily adjusted by appropriate selection of the fabric design and mesh.

If still greater improved soil release characteristics are required in the fabrics of this invention, it is possible to coat them with a nanoparticle type coating according to the methods described in WO 06/098917. The fabric may be coated with the nanoparticle treatment by various means while in use, and cured using existing heat sources to obtain temperatures of between 32° C. and 120° C., or the fabric can be so treated by the manufacturer prior to delivery to the customer. The coating will impart oleophobic and hydrophobic properties to the fabric which, in combination with the surface roughened yarns, will provide further improvements to the soil release properties of the fabric. Such characteristics can be further improved by employing surface roughened yarns that are formed from PTFE (Teflon®) and/or by using PTFE yarns as a portion of either the warp and/or weft yarns in the fabric.

An unexpected benefit provided by the fabrics of this invention relates to their ability to hold the nonwoven product that is being formed (referred to as “hold-down”) upon them without fiber snagging. Fiber snagging occurs when the component fibers of the nonwoven being formed become entrapped between the monofilament yarns of the fabric upon which the nonwoven product is formed. It has been found that roughened surface yarns such as may be employed in the fabrics of this invention, in particular surface roughened yarns having a substantially rectangular cross-section, provide significantly fewer locations in the fabric for snagging to occur.

Hold-down relates to the propensity of a fabric to retain the nonwoven web upon its surface during manufacture. As discussed above, the spunmelt process utilizes a molten polymer that is extruded from a spinneret to produce a curtain of polymeric strands. For example, as shown in U.S. Pat. No. 5,814,349 (Geus et al/Reifenhauser GmbH) an air flow is used to aerodynamically stretch, elongate or attenuate the strands which, after passing through a diffuser, are deposited onto the forming fabric. Presses are used to compress the deposit of filaments. The volume of air moved over and through the fabric during the forming process can be very large. Air leakage can occur between the fabric and presses, or through the fabric. This leakage can be attributed in part to air that is carried by the fabric, the fabric surface roughness and its thickness. As the speed of the fabric increases, air carried by the fabric can cause the web to flutter or follow one of the press rolls, which is undesirable. It is difficult for the fabric manufacturer to obtain the optimum balance between fabric surface properties and the web conveyed thereon to ensure reliable transfer of the nonwoven product to the press area. It has been found that the fabrics of this invention address this problem advantageously, being effective in seeking to provide an appropriate balance between surface roughness and fiber snagging to ensure the reliable transfer of the nonwoven product.

1-24. (canceled)

25. A fabric for use in the production of a nonwoven web of material, having a web-contacting surface and comprising a plurality of component systems of monofilament polymeric yarns, including
(a) at least a first system comprising machine direction yarns;
(b) at least a second system comprising cross-machine direction yarns; and
(c) at least a third system of yarns comprising conductive polymeric yarns oriented in one of the machine direction and the cross-machine direction,
wherein at least some of the yarns of at least one of the first and second systems comprise surface roughened yarns having a substantially flat surface which
(i) is exposed in the web-contacting surface and
(ii) has a surface roughness between 5 μm and 100 μm.

26. A fabric according to claim 25, further comprising a fourth system of yarns comprising conductive polymeric yarns oriented in a direction transverse to the yarns of the third system.

27. A fabric according to claim 25, comprising at least two systems of cross-machine direction yarns.

28. A fabric according to claim 25, wherein the surface roughened yarns have a cross-sectional profile selected from the group consisting of square, rectangular, D-shaped, ovate and elliptical.

29. A fabric according to claim 28, wherein the cross-sectional profile is rectangular.

30. A fabric according to claim 25, wherein each of the surface roughened yarns has a ratio of width to maximum profile thickness between 1:1 and 6:1.

31. A fabric according to claim 30, wherein the ratio is from 1:1 to 3:1.

32. A fabric according to claim 25, wherein the yarns are constructed of a polymer selected from the group consisting of polyethylene terephthalate (PET), polybutylene terephthalate (PBT), polyethylene naphthalate (PEN), polyethylene, polytetrafluoroethylene (PTFE), polyamide, polyphenylene sulfide (PPS), and polyetheretherketone (PEEK).

33. A fabric according to claim 25, wherein the air permeability is between 300 and 1,000 cfm/ft².

34. A fabric according to claim 25, which is woven according to a design selected from one of a single layer weave, 1½ layers, double layer, extra support double layer, triple layer, surface support binder (SSB) and warp tie.

35. A fabric according to claim 26, comprising at least two systems of cross-machine direction yarns.

36. A fabric according to claim 26, wherein the surface roughened yarns have a cross-sectional profile selected from the group consisting of square, rectangular, D-shaped, ovate and elliptical.

37. A fabric according to claim 36, wherein the cross-sectional profile is rectangular.

38. A fabric according to claim 26, wherein each of the surface roughened yarns has a ratio of width to maximum profile thickness between 1:1 and 6:1.

39. A fabric according to claim 38, wherein the ratio is from 1:1 to 3:1.

40. A fabric according to claim 26, wherein the yarns are constructed of a polymer selected from the group consisting of polyethylene terephthalate (PET), polybutylene terephthalate (PBT), polyethylene naphthalate (PEN), polyethylene, polytetrafluoroethylene (PTFE), polyamide, polyphenylene sulfide (PPS), and polyetheretherketone (PEEK).

41. A fabric according to claim 26, wherein the air permeability is between 300 and 1,000 cfm/ft².

42. A fabric according to claim 26, which is woven according to a design selected from one of a single layer weave, 1½ layers, double layer, extra support double layer, triple layer, surface support binder (SSB) and warp tie.

43. A fabric according to claim 25, wherein the fabric is a spiral link fabric comprising coils of helically assembled yarns, and the surface roughened yarns are at least some of the helically assembled yarns.

44. A fabric according to claim 43, wherein the surface roughened yarns have a cross-sectional profile selected from square, rectangular, ovate and elliptical.

45. A fabric according to claim 44, wherein the cross-sectional profile is rectangular.

46. A fabric according to claim 43, further comprising a set of cross-machine direction stuffer yarns inserted into the coils, wherein at least some of the stuffer yarns are surface roughened.

47. A fabric according to claim 46, wherein the surface roughened stuffer yarns have a cross-sectional profile selected from square, rectangular, D-shaped, ovate and elliptical.

48. A fabric according to claim 47, wherein the cross-sectional profile is rectangular.

49. A fabric according to claim 43, wherein each of the surface roughened yarns has a ratio of width to maximum profile thickness between 1:1 and 6:1.

50. A fabric according to claim 49, wherein the ratio is from 1:1 to 3:1.

51. A fabric according to claim 43, wherein the helically woven yarns are constructed of a polymer selected from the group consisting of polyethylene terephthalate (PET), polybutylene terephthalate (PBT), polyethylene naphthalate (PEN), polyethylene, polytetrafluoroethylene (PTFE), polyamide, polyphenylene sulfide (PPS), and polyetheretherketone (PEEK).

52. A fabric according to claim 43, wherein the air permeability is between 300 and 1,000 cfm/ft².

53. A fabric according to claim 25 for a spunmelt process.

54. A fabric according to claim 26 for a spunmelt process.

55. A fabric according to claim 43 for a spunmelt process.

56. A fabric according to claim 25 for an airlaid process.

57. A fabric according to claim 26 for an airlaid process.

58. A fabric according to claim 43 for an airlaid process.

59. A fabric according to claim 53 for a production step selected from forming, bonding, drying and transfer of the nonwoven web.

60. A fabric according to claim 56 for a production step selected from forming, bonding, drying and transfer of the nonwoven web.

61. A fabric according to claim 25, wherein at least a part of the web-contacting surface is additionally coated with a nanoparticulate coating having at least one of oleophobic and hydrophobic properties.

62. A fabric according to claim 26, wherein at least a part of the web-contacting surface is additionally coated with a nanoparticulate coating having at least one of oleophobic and hydrophobic properties.

63. A fabric according to claim 43, wherein at least a part of the web-contacting surface is additionally coated with a nanoparticulate coating having at least one of oleophobic and hydrophobic properties.
